(19) United States
(12) Patent Application Publication
(10) Pub. No.: US 2006/0180008 A1
(43) Pub. Date: Aug. 17, 2006

(54) Universal unitary computer control for MIDI devices

(75) Inventors: Craig Negoescu, Austin, TX (US); Joel Willard, Austin, TX (US); Lary Cotten, Austin, TX (US)

Correspondence Address: HEINZ GRETHER PC, 5810 TRADE CENTER DR., SUITE 300, AUSTIN, TX, 78744, US

(73) Assignee: Open Labs, Inc.

(21) Appl. No.: 11/333,808

(22) Filed: Jan. 17, 2006

Related U.S. Application Data
(60) Provisional application No. 60/644,940, filed on Jan. 19, 2005.

(51) Int. Cl. G10H 7/00

(52) U.S. Cl. 84/645

(57) ABSTRACT

An improved driving midi devices that provides a unitary driver for multiple midi devices and a universal drive that can configure drivers for midi devices even if no midi driver exists for the device is described.

### TECHNICAL FIELD

The present invention relates generally to control of input devices for personal computing systems and devices. More specifically, the invention relates to the control of midi devices for personal computing systems and devices.

### BACKGROUND OF THE INVENTION

Open Labs, Inc. (Open Labs) of Austin, Tex. has been at the forefront of new paradigms related to the application of computer technology to Musical performance and Audio production and their application for the needs of musicians and professional and hobbyist audio engineers. One major area of development has been with the user interface and user experience. With in the area of user interface, one particular area of development has related to the integration of diverse midi control surfaces to a computer system.

FIG. 1 illustrates a typical computer system with a midi input device. Typically the computer 10 will have several peripheral devices attached. For example in FIG. 1 the computer has attached a visual display 12 attached and also an alphanumeric keyboard 14 and a pointing device 16. In order to function with these peripheral devices the computer must have software drivers installed so that the computer can drive these peripheral devices. For musical applications, there are numerous other peripheral devices available that can be connected to the computer. Typically, these devices are connected to the computer via a standard midi connection or a midi over USB connection. One such music application midi device 20 is illustrated in FIG. 1 with a musical keyboard 22 and various other control inputs 24, 26, 28, 30 & 32.

Midi and USB are both well-known industry standard protocols. The midi protocol includes electrical, mechanical and communication elements. Midi over USB uses midi communication protocol elements as part of its communication protocol but uses the electrical and mechanical protocols from the USB protocol. In order for these midi devices to be used properly with a particular software application, not only must a driver be installed on the computer, but also the driver must include a mapping so that midi peripheral will function properly with the software application. Typically only one midi device can be used with an application and only one application can be used with a midi device. These limitations greatly limit the flexibility of the user and frustrate the user that they cannot use any midi with their choice of software or combinations of software and/or in combination with other midi devices.

### BRIEF DESCRIPTION OF THE DRAWINGS

A better understanding of the present invention can be obtained when the following detailed description of the disclosed embodiments is considered in conjunction with the following drawings, in which:

FIG. 1 illustrates an example of a typical configuration of a computer system connected to a midi control board;

FIG. 2 illustrated a computer system configuration connected to multiple midi control boards;

FIG. 3 illustrates an application for an improved driver for midi devices;

FIG. 4 illustrates another application of a unitary midi driver for midi devices;

FIG. 5 illustrates the architecture of a unitary universal USB driver;

FIG. 6 illustrates a flow diagram of the for assignment of midi device drivers within the unitary universal midi driver of FIG. 5;

FIG. 7 illustrates the hierarchical nature of the midi control panel provides to the user for organizing configurations of one or a plurality of midi control boards;

FIG. 8 illustrates an example of a virtual control surface for a recognized predefined control surface and the UI for configuration of a pot type control (knob in this case);

FIG. 9 illustrates and example of a UI for an encoder type control;

FIG. 10 illustrates an example of a UI for a button type control;

FIG. 11 illustrates an example of a UI for key split control;

FIG. 12 illustrates an example of a UI for midi master control; and

FIG. 13 illustrates an example of a virtual x/y control input

### DETAILED DESCRIPTION OF THE FIGURES

Although described with particular reference to a midi input devices for computer based musical applications, the claimed subject matter can be implemented in any electronic system which is designed to receive input from a control panel or multiple control panels. Those with skill in the computing arts will recognize that the disclosed embodiments have relevance to a wide variety of computing environments and applications in addition to those described. In addition, portions of the system and methods of the disclosed invention can be implemented in software, hardware, or in differing combination of software and hardware. Some hardware portions can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory and recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

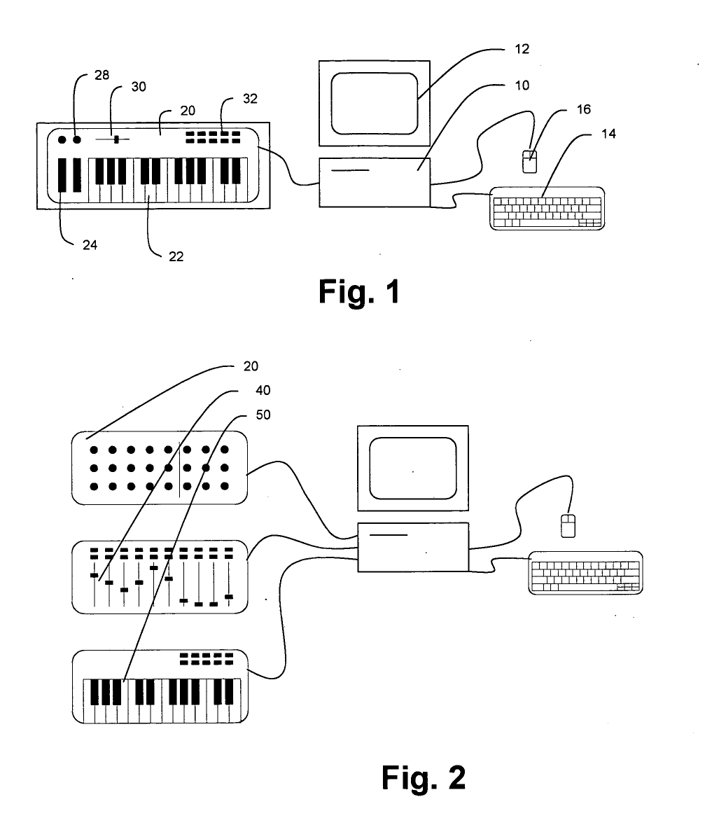

As previously described, FIG. 1 is an illustration of an example of a typical computer 10 system configuration with a midi peripheral device 20 connected to the computer 10 system. For the computer 10 and peripheral 20 to function properly, a driver (not shown) must be installed in the computer 10 to drive the midi peripheral device 20. Usually this driver is takes the form of a software driver. In order for the computer 10 and peripheral 20 to function properly with a particular software application, the control input devices like 22, 24, 26, 28, 30, and 32 on the peripheral input device 20 must be mapped to desired functionalities within a particular software application to function properly. Without the driver specific to other software application, the user was limited to using the peripheral midi device with software applications for which drivers could be obtained. With the universal driver described below provides the user with the capability of using any midi device with software for which there is no predefined driver.

FIG. 2 illustrates a desirable computer 10 system configuration. In this configuration several midi devices 20, 40, 50 are connected to the computer 10 system. Unfortunately, most computer 10 systems do not allow multiple midi devices unless the system includes multiple sound cards (not shown). Even with multiple sound cards, it may not be possible to use multiple devices with a single software application or multiple applications.

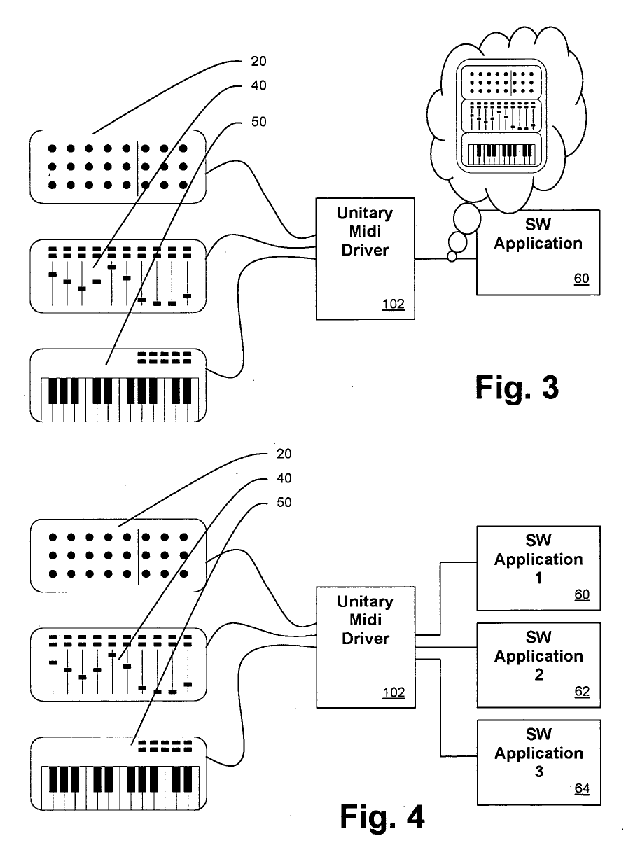

FIG. 3 illustrates a unitary driver 102. The unitary driver 102 combines all of the midi devices 20, 40 & 50 connected to the computer system and makes them appear to be a single midi device to the software application 60 and to other components of the computer 10 system such as the sound card (not shown). Since the software applications see only one device, in reality they are capable of receiving inputs from multiple midi devices simultaneously and sending midi instructions to multiple midi devices.

FIG. 4 illustrates another capability of the unitary driver. The unitary driver 102 allows the user to map the midi driver to multiple software applications. The unitary driver 102 can be mapped so that all or some of the controls of one midi device 20 could be mapped to one software application 60; while all or some of the controls of a second midi device 40 could be mapped to a second software application 62; and the controls of a third midi device 50 could be split so that some of its controls are mapped to one application 60 and some are mapped to another application 62 or 64. The unitary driver 102 can also be mapped so that it multi-casts so that one control is mapped to multiple applications or on multiple midi channels.

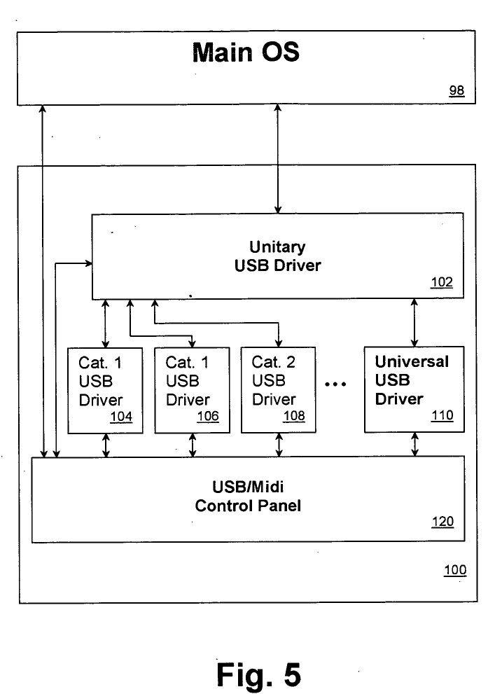

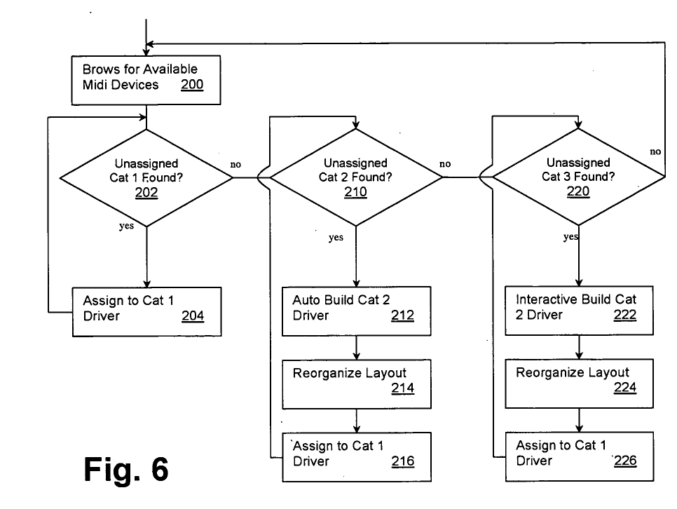

FIG. 5 illustrates the architecture of software components enabling the operating system 98 (“OS”) of the computer system to see and treat all of the midi devices as a single unitary device. The unitary driver 102 is part of the universal, unitary driver 100. The unitary driver 102 receives and sends information to and from multiple midi device drivers 102, 104, 106 and 108. The midi devices are assigned to separate device drivers 102, 104, 106, and 108 as described below in connection with the detailed description of FIG. 6.

FIG. 6 illustrates a procedure for assigning midi devices to midi device drivers. The process begins by the operating system of the computer system browsing the system to determine what midi devices are available 200. This is an ongoing process. It involves querying connected devices, and/or receiving identifying information from a connected device, and/or detecting that it has received midi formatted information. In the preferred embodiment, the user is provided with the option of turning off this routine or at least preventing it to interrupt the user. In some embodiments, this option is automatically invoked when the system is placed into a performance mode. In other embodiments in order for the browsing routine to function and interrupt the user, the system must be actively placed into a configuration mode.

As the Operating System browses the system for available midi devices, the system categorizes the available midi devices into a plurality of categories of midi devices. FIG. 6 illustrates an example of categorization of midi devices into one of three (3) categories and assigns each to an appropriate midi device driver(s). The first category of device the system looks for are category 1 devices 202. A category 1 device is a midi device that is predefined and the computer system already has a device driver for that particular device in its library. If such a device is found, then it is assigned to the category one driver in the system library 204. Then the system proceeds to look for more category 1 devices 202. Each category 1 device is assigned an appropriate driver from the midi driver library 204.

After all of the category 1 devices have been found, the system proceeds to look for category 2 devices 210. A category 2 device is a device that has been predefined by the manufacturer according to a special protocol but for which the computer system does not have driver in its library. If a category 2 device is found, then a new routine is initiated 212. This routine is a non-interactive (or semi-interactive) routine between the midi device in which the system queries the midi device for information about it like how many and what type of controls does it employ. From the information derived from the midi device a generic midi driver is constructed and mounted on a new virtual midi device on the virtual midi Control Panel. This user is then provided with the option of reorganizing the layout of the self-configured driver in the GUI created in the midi control panel 214. Then the midi device is assigned to the newly configured device driver 216. The system then looks for additional category 2 devices. If another category 2 midi device is found, these steps 212, 214, and 216 are repeated for the new category 2 device. This process repeats until all of the category 2 midi devices have been identified and assigned to a midi driver.

After all of the category 2 devices have been found, the system looks for category 3 midi devices 220. A category 3 midi device is a midi device that has neither been predefined nor is there a driver for it in the midi driver library of the computer system. If a category 3 device is found, then an interactive process may be used by the user to create a midi driver for that device 222. If an undefined midi device is detected, the Virtual midi Control Panel will create a GUI interface for the device. A user interactive process for building the driver will be described in greater detail below. The user is also provided with the opportunity to reorganize the physical layout of the GUI virtual representation of the midi device in the USB Control Panel 224. In any case, the device will then be assigned to a universal midi device driver 226. This categorization process results in a universal midi driver that can drive any midi device regardless of whether a predefined midi driver for that midi device has been installed on the computer system or even exists at all.

With all of the midi devices assigned to their respective midi drivers we return to the architectural illustration in FIG. 5. The midi device drivers 104, 106, 108 and 110 only communicated with by the OS 98 for very limited purposes. When passing information to other system components like particular software application so that all of the midi devices can be used, the OS primarily communicates with the unitary midi driver 102. Likewise the midi device drivers 104, 106, 108 and 110 primarily communicate with the unitary midi driver 102. However, the midi device drivers 104, 106, 108 and 110 also communicate with a midi Control Panel 120.

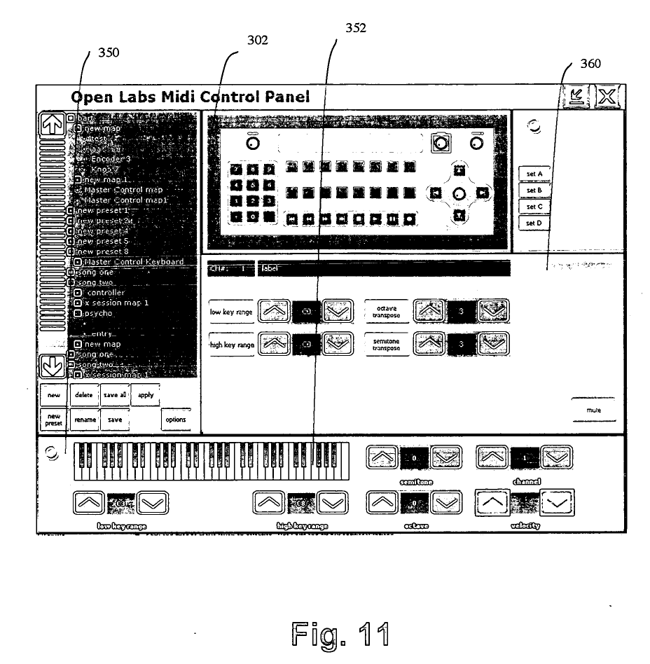

The midi Control Panel 120 provides the user with a graphical user interface (“GUI”). In other words, the midi Control Panel 120 is actually a virtual control panel. The midi Control Panel 120 provides the user with configurational and mapping control over the midi device drivers 104, 106, 108, 110. The midi Control Panel 120 can also communicate directly with the OS 98 and with the Unitary Driver 102. The benefits of this line of communication will be appreciated in the configuration of controls for particularly types of midi control inputs described below—particularly in regard to push button controls in FIG. 10.

In the embodiment illustrated in FIG. 5, the drivers are specified as USB drivers. It is not important to the invention that the drivers be USB drivers. Other types of drivers are possible and likely. It is also not necessary that all of the drivers be of the same type some could be firewire, some USB and some could be true midi. It should also be appreciated that the number of midi device drivers 104, 106, 108, 110 is variable. There may be one driver per connected midi device, there may be instances where one driver may drive multiple midi devices. In fact, in one embodiment developed by the inventor's, the Universal USB driver 110 drives all of the category 3 USB devices. The USB midi Control Panel 120 also communicates with the Unitary USB Driver 102.

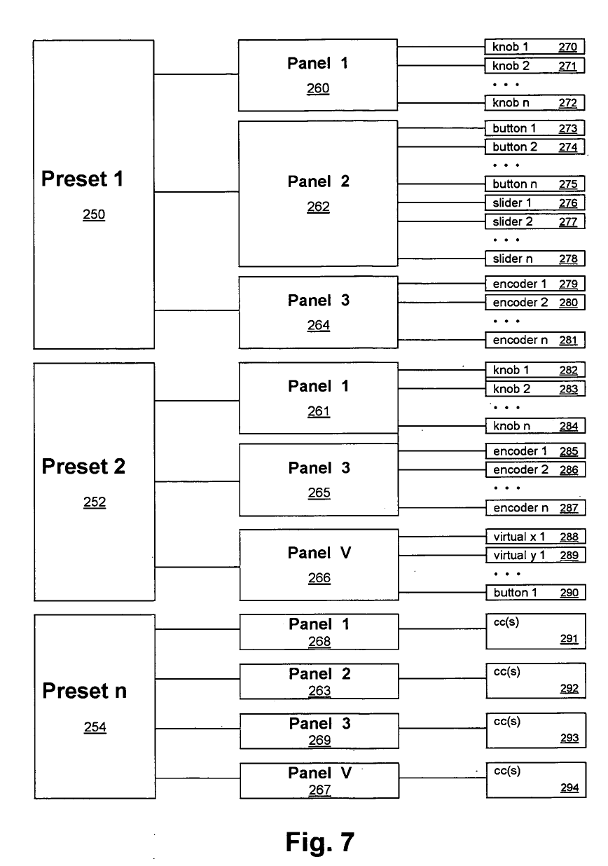

In addition to configuring the individual USB device drivers, the USB midi Control Panel also provide hierarchical control of the Unitary Universal midi driver. An embodiment of this hierarchy is illustrated in FIG. 7. At the top of the hierarchy are presets 250, 252, 254. Each presents is mapped to a number of midi panels. For example Present 1 250 is tied to three midi panels: panel 1 260, panel 2 262 and panel 3 264. Preset 2 is also mapped to panel 1 260 and panel 3, 264. But instead of panel 2 it is mapped to panel V 266. Preset 3 is mapped to panels 1, 2, 3, and V. Each panel in turn is connected to a list of controls on that panel.

For example in Preset 1 250: Panel 1 260 has n pot type knob controls 270, 271, 272; Panel 2 262 has n buttons 273, 274 & 275 and n pot type sliders 276, 277 & 278 (the n for buttons and sliders may or may not be equivalent in number); and Panel 3 264 has n encoders 279, 280 & 281. Each preset, panel and control may be renamed by the user.

In another example, Preset 2 252: the controls for Panel 1 261 and Panel 3 265 are different that their configurations in Preset 1 250; and Panel V 266 has a virtual x pot type control 288 and a virtual y pot type control 289 and a button control 290.

In a third example, Preset 3 254: Panel 1 268, Panel 2 263, Panel 3 269 and Panel V 267 are all connected with their own set of respective control configurations 291, 292, 293, & 294.

The user may edit, copy, delete or create many presets and panels and control configurations. In the preferred embodiment, the midi control panel allows the user to specify which preset the system starts with. One of the presents that can be specified is the last preset used by the user.

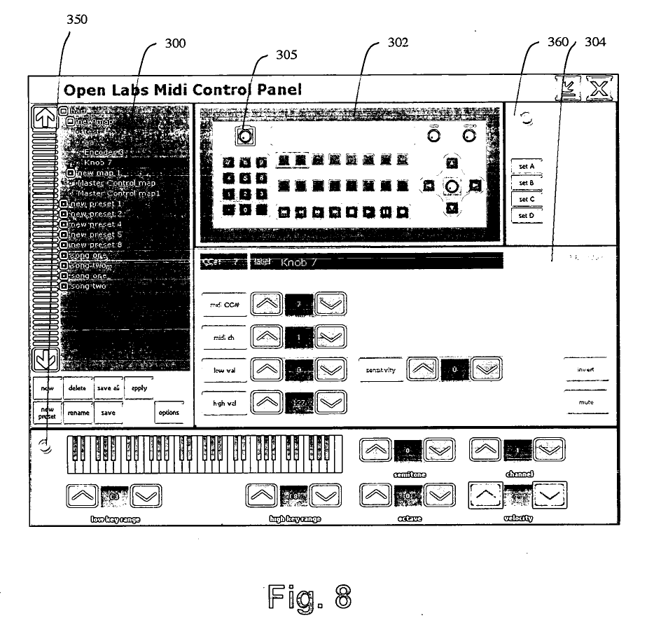

FIG. 8 is an illustration of a screen shot of the Virtual midi Control Panel of FIG. 5. The upper left hand block 300 is a hierarchical map of where the user is in the control panel. In this illustration the user is looking at the configuration of “Knob 7” in panel “new map” in present “bart”. In the embodiment shown the hierarchy is nested. This can be confusing if the nested lists become long. In a preferred embodiment (not shown) of the hierarchical map, the presets, panels and controls would be in different blocks with the current preset, panel and control—each highlighted. A non-nested map it is easer for the user to see where they are relative to other presets and other panels even if the lists are long. GUI of the selected panel is illustrated in block 302. The GUI illustrated is of a category 1 midi device. For a category 2 and category 3 midi devices the user may want to physically reorganized controls in the GUI to more closely match the physical layout of the controls on the physical midi device.

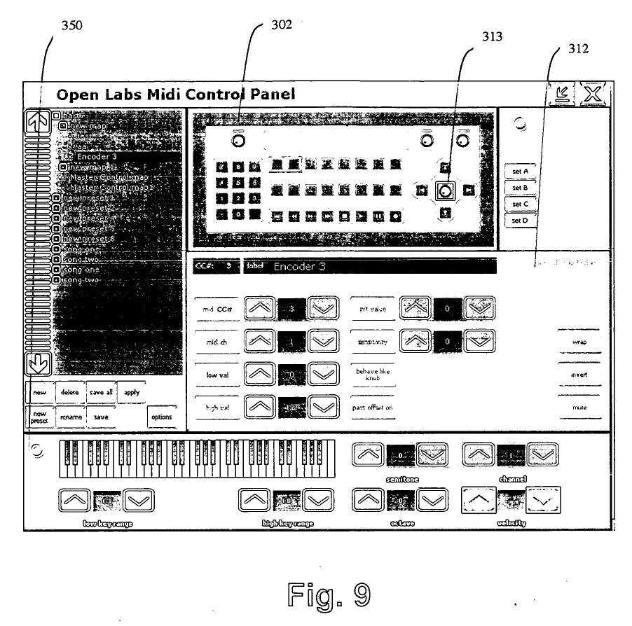

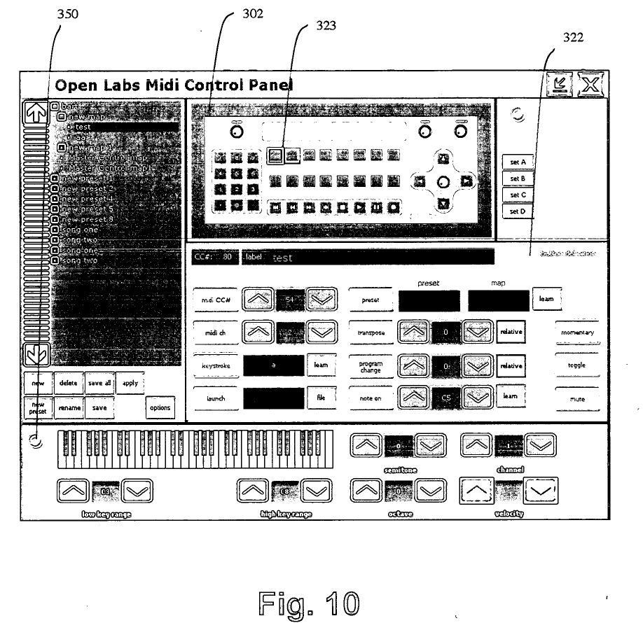

Knob 7 is highlighted in block 302 and the configuration parameters of this control are detailed in block 304. The embodiment shown allows the user to re set the controls cc number (“midi cc#”) which is currently set at “7” in this example. Is also allow the user to reset the midi channel assignment which is currently set at “1” in this example. A Knob type control is frequently characterized as a pot type control. It is a control that typically has physical stops at both ends of its range of motion and typically as a physical device provides absolute position data rather than relative position data. Typically pot type controls take the form of a knob or a slider. In the embodiment shown the range of numbers that are set for the total range of motion of the knob are set by the “low val” currently set at “0” and the “high val” currently set “127”. The embodiment shown also provides the user with an “sensitivity” setting. This setting will allow the knob to have a limited number of settings with in the range. In some embodiments, this setting will determine how much the knob needs to rotate to move to the next setting. For example a setting of “16” will allow the knob to have “8” different outputs evenly spaced across its range of motion. In other embodiments, this setting will determine the number of outputs directly for example a setting of “8” will resulting in “8” different outputs evenly spaced across its range of motion. In other embodiments the user is able to pick either one of the two above methods of setting sensitivity. The embodiment shown also allows the user to invert the output with the “invert” selection. This will invert the output. By way of example inverting the out cause the “0” output at one range of motion becomes “127” and the “127” output at the other end of the range of motion to become “0” in effect changing the effect of direction of rotation of a knob or the effect of the direction of sliding a fader. The embodiment shown also allows the user to mute the output from this control my selecting the “mute” option. Although not shown in the embodiment illustrated in FIG. 9, the user is also provided with an option of muting the whole midi control without changing the preset setting. The user is also provided with the ability to rename the control by typing a new name in the field next to “label.” In the embodiment shown, the definition of the type of control in the upper right hand corner of block 304 remains—in this case “pot definition: to identify the general type of control.

In FIG. 9 a different control 310 is highlighted in the GUI panel block 302. In this case the control is an encoder type control. Encoders typically do not have physical stops and typically transmit relative position or movement rather than absolute position. They are able to output continual information of movement. FIG. 9 illustrates a GUI for defining the characteristics of an encoder control in block 312. Once again the midi cc# and midi channel can be reset. In the example illustrated they are currently set at “3” and “1” respectively. The user can also set a low and high range for the controls value output, currently set at “0” and “127”. The user can set the sensitivity of the control in the same manner as with a pot control with the difference that the encoder can switch between the highest values and the lowest value (by continued rotation) without cycling through the intermittent values. In the embodiment shown, the user is also able to set the start value. Unlike a pot which provides absolute position data, an encoder only outputs changes in position so it is useful to be able to set the initial position value for the encoder. The user is also able to select either “behave like a knob” or “pass offset on.” Behave like a knob will allow the user to obtain output values from one end of the range to the other continued rotation will be ignored and the value will stay at one end of the value range or the other. Once direction of rotation is changed the value will begin to move in the direction of the opposite value range. “Pass offset on will allow the encoder to carry rotations. The user is also provided with the option of selecting that the encoder “wrap” to the opposite end of the range output values if the encoder is rotated past one end of the value range or another. The user is also provided with the option of inverting the effect of encoder's movement and the option to mute the output as described for a pot type control above.

In FIG. 10 a different control 320 is highlighted in the panel GUI block 302. In this case the control is push button. FIG. 10 illustrates a GUI for defining the characteristics of push button control in block 322. Once again the midi cc# and midi channel can be reset. In the example illustrated they are currently set at “54” and “2” respectively. The user is also provided with the option of selecting a keystroke when the button is pushed. In the example shown the keystroke selected is “a”. The user can either enter the keystroke(s) in the field provided or can select “learn” and enter the desired keystrokes on the currently or another device connected to the computer system. In operation this information will be managed by the midi Control Panel which will provide the instruction directly to the OS and on to the relevant software application. In this manner, the Unitary Universal midi Controller is also capable of using midi devices to output non-midi instructions. Another way provided to the user of using a midi device to output non midi commands is by the “launch” option. In this option, the user can enter a file name of a program or a content file. The user can either type in the path to the file or can choose “file” which will open a GUI window from which the user can graphically browse for and select a file that he would like to launch when the midi button control is selected.

The user is also provided with the option of having the button mapped to select a preset created in the midi control panel and a map to use in the preset. Both of these selections can be typed in or can be graphically selected by selecting “learn”. Using the “transpose” function causes the button to jump to a set value or by also selecting “relative” in line with transpose to cause an incremental increase by the set value from the current value. The user is also provided with the “program change” option. With these option the user can set the button to select a particular voice or sound. For example, every time the button is pushed the voice will change to a grand piano. If “relative” is selected, the program will increment by the number selected to another sound on the system library list. For example, if relative is selected and the current sound is a grand piano and the next voice on the program list is an organ, then pressing the button will change the voice to an organ. By inserting a number in the field provided the button may increment up or down the voice/plug-in list skipping the voices/plug-ins in between.

In the embodiment shown, the user is also provided with the option of having the button play a note (in the example shown the button is programmed to play a “C5”) which is the midi code for a particular note on the keyboard or virtual keyboard of some other input device. The use is provided with the option of “leaning the note which means rather than typing the notes midi code the user can select “learn” and play the note. The user is also provided the option of selecting “momentary” output (or non-momentary”). The effect of pressing the button will provide a pulsed output regardless of how long the button is depressed. Although not shown in the embodiment illustrated in FIG. 10, in the preferred embodiment the user is capable of setting the length of the pulse. Alternatively, the output from the button will continue as long as the button is held down. The user is also provided with a “toggle” selection. This selection opens another configuration window (not shown) In the embodiment shown by selecting the toggle, the button will cycle between two or more states with successive activation. In other words, if the button's current state is “1”, pressing the button once will cycle the state to “2” pressing it again will cycle the state to “1” again. The user is provided with the option of determining how many different states the button will toggle through and is also provided with the option of setting the value for each state. In the embodiment shown the user is provided with the option of muting the output from the button. Though not shown in FIG. 10, in the preferred embodiment the user is provided with the option of programming a button to mute an entire midi device.

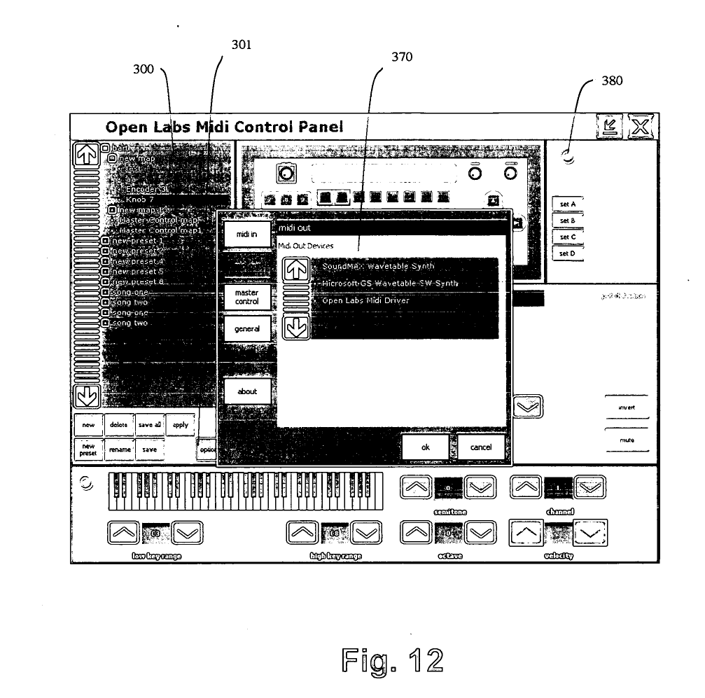

FIG. 11 is an illustration of a control settings particular to a musical keyboard style midi input control board. It will be appreciated by a person skilled in the art that in the virtual midi Control Panel illustrated in FIG. 8, FIG. 9, FIG. 10, FIG. 11 and FIG. 12, many of the keyboard controls are always present at the bottom of the control panel in block 350 because they are controls that a user performing may like to have quick access to these settings. However in the embodiment illustrated the user is provided with some additional keyboard settings which are not provided in block 350, in an alternative embodiment all of these controls may be provided in block 350. The musical keyboard settings provided in block 360 relate splitting the keyboard assignment. For example, the user may want one half of the keyboard to be assigned to extreme low range octaves and the other half to be assigned to extreme high range octaves. Alternatively the user may want both halves of the keyboard assigned to the same octaves but use them to play different voices. For example the user could play piano on one half of the keyboard and drums or guitar on the other half of the keyboard but all within the same octaves.

FIG. 12 is an illustration of the master control interface 370 for the virtual midi control panel. This window is invoked by pressing the options button 301 in the hierarchy block 300. In this window the master control can be set and the midi in and out ports can be set. The other controls in the hierarchy block 300 (“new”, “delete”, “save,” “save all,” “apply,” “rename,” and “new preset,”) are all self-explanatory. They can be used respectively to create, delete, save, save all, apply or rename presets and panels and controls to create and manage different system configurations.

As previously mentioned the control panel also provides the user with the option of multicasting outputs/inputs. This functionality, provided in block 380 of the control panel, allows the user to broadcast the same midi signal on multiple midi channels.

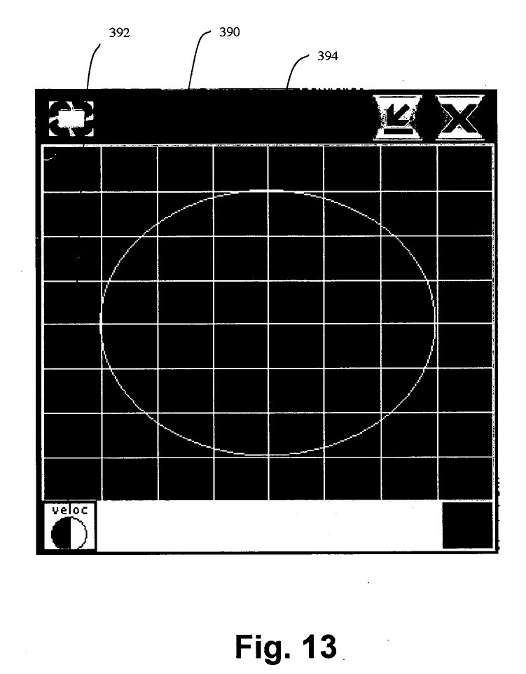

FIG. 13 is an illustration of a virtual x, y and/or x/y control 380. This control will receive input from any pointing type input device such as a mouse, touch screen etc. By moving the pointing device the virtual display 380 gives the user feedback concerning the current position. The configurational controls for a virtual x or a virtual y control would be either a pot definition described in FIG. 8 or an encoder described in FIG. 9. For a virtual x/y control two pots definitions, or two encoders or one of each would be appropriate—one for movement along the x-axis 392 and one for movement along the y-axis 394.

The preferred embodiment of the invention also contains a configurational control template for drum pad based controls similar to the templates for pot controls, encoder controls, and virtual x/y controls discussed above. In the preferred embodiment the drum pad control would include the variables controllable for a keyboard including velocity but also a trigger time control and layering control.

The control panel also provides the user with the functionality of typing control labels in the GUI panel for a midi control device. It also provides the user with the option of generating a printable die punch file representative of the actual size of the control with die markings for cutting the print to generate an overlay to place about the actual physical control panel thereby labeling the controls. In the preferred embodiment two versions of the label die would be provided, one that fits over the existing knobs, buttons and sliders but and also a version that would fit after the knobs and handles, and button covers are temporarily removed.

With the control configurations described above, a user can remap a midi device by changing the channel numbers and cc# to match the channel and number expected by a software program to which a control is to be mapped. In the preferred embodiment, the user is Control panel provides a block next to the hierarchy block 300 which mirrors the hierarchy block. This mirrored hierarchical block would be used to graphically map controllable parameters in a computer software application to the midi controls in the third tier in block 300. The second tier in the mirrored block references groups of parameters and the third tier represents software application of which there could be one or many. The midi control could then be graphically mapped to an application control parameter simply by drawing a connecting line between the two hierarchies.

While the invention has been shown and described with reference to particular embodiments thereof, it will be understood by those skilled in the art, that the foregoing and other changes in form and detail may be made therein without departing from the spirit and scope of the invention, including but not limited to additional, less or modified elements and/or additional, less or modified blocks performed in the same or a different order.

We claim:

1. A computer comprising:
a central processing unit;
a communications link capable of physical connections with multiple midi devices
unitary driver software for coordinating communications with multiple midi devices.
